(19) United States
(12) Patent Application Publication
(10) Pub. No.: US 2025/0122096 A1
(43) Pub. Date: Apr. 17, 2025

(54) LITHIUM ION BATTERY POSITIVE ELECTRODE MATERIAL, AND PREPARATION METHOD THEREFOR AND USE THEREOF

(71) Applicants: INSTITUTE OF PROCESS ENGINEERING, CHINESE ACADEMY OF SCIENCES, Beijing (CN); LANGFANG GREEN INDUSTRIAL TECHNOLOGY CENTER, Hebei (CN)

(72) Inventors: Qiangqiang TAN, Beijing (CN); Xueqian JI, Beijing (CN)

(21) Appl. No.: 18/568,298

(22) PCT Filed: Dec. 14, 2021
(86) PCT No.: PCT/CN2021/137698

§ 371 Date: Dec. 8, 2023

(30) Foreign Application Priority Data
Oct. 11, 2021 (CN) 202111181292.X

(51) Int. Cl. C01G 53/502; H01M 4/02; H01M 4/04; H01M 4/505; H01M 4/525; H01M 10/0525

(52) U.S. Cl. CPC C01G 53/502; H01M 4/0471; H01M 4/505; H01M 4/525; H01M 10/0525; H01M 2004/028

(57) ABSTRACT

The present application relates to a lithium ion battery positive electrode material, and a preparation method therefor and the use thereof. The preparation method comprises the following steps: (1) preparing a mixed solution from a raw material containing metal ions, a polymer and a solvent, independently leaving same and an ammonium source to stand in the same space, and subjecting same to solid-liquid separation to obtain a precursor, and (2) mixing and calcining the precursor in step (1) and a lithium source to obtain a lithium ion battery positive electrode material.

### TECHNICAL FIELD

The present application relates to the field of lithium-ion battery materials, and relates to a positive electrode material for lithium-ion batteries, a preparation method therefor and an application thereof.

### BACKGROUND

As the energy demand is increasing, lithium-ion battery on the market has attracted widespread attention due to high specific capacity; high working voltage, low price, environmental friendliness and good cycle stability since its debut. At present, the mainstream positive electrode material for the lithium battery are LiCO₂, LiNiO₂, a ternary material LiMO₂, LiMn₂O₄ and xLi₂MnO₃·(1−x)LiMO₂, etc. The preparation methods of the positive electrode material for lithium-ion battery are mainly divided into solid-phase method and liquid-phase method.

The high-temperature solid-phase method has a simple process, but the material has an uneven phase distribution, irregular grain shape and wide particle size distribution, whose electrochemical performance is inferior to that of the electrochemical material prepared by the liquid-phase method. The liquid-phase method mainly comprises high-temperature phase method, co-precipitation method, hydrothermal method, solvothermal method, sol-gel method and spray drying method, etc. The material prepared by liquid-phase method has good chemical homogeneity, high purity and narrow particle size distribution range, but generally, the electrochemical performance of the material are affected by pH, reaction temperature, stirring speed, calcination temperature, calcination time and other conditions.

Wang et al. (Wang, 2013, Electrochimica Acta) prepare a nanoscale Li_{1.2}Mn_{0.6}Ni_{0.2}O₂ positive electrode material by co-precipitation method, and the discharge specific capacity after 60 cycles is only 181.1 mAh g⁻¹ . Dannehl et al. (Dannehl, 2018, ACS Applied Materials & Interfaces) prepare a Li_{1.2}Mn_{0.55}Ni_{0.15}Co_{0.1}O₂ positive electrode material by sol-gel method, and the capacity retention rate is only 58% after 20 cycles at the charge-discharge condition of 2-4.8 V and the current density of 25 mA g⁻¹. In addition, during the preparation process of the precursor, stirring, heating and other reaction processes, which consume a lot of energy, are usually required in the liquid-phase method, especially the co-precipitation method commonly used in industry, and the treatment of the three wastes greatly increases the cost.

CN102569723A discloses a positive electrode material for lithium-ion batteries and a preparation method therefor, and a positive electrode and a lithium-ion battery. The positive electrode material for lithium-ion batteries comprises: a conductive agent: a nanophosphate salt, which has a general formula of LiMPO, wherein M is one or more of Co, Ni, Mn, Fe and V; and a functional polymer material, wherein the functional polymer material contains a functional group for chelating transition metal ions. By the chelation of the functional group for chelating transition metal ions in the functional polymer material, the metal impurity ions dissolved out from the surface of positive electrode material are captured. and the migration of impurity ions is inhibited. thus avoiding the precipitation of metal ions on the negative electrode, reducing the self-discharge and safety risks of the battery, thereby improving the cycle performance and high-temperature storage performance of the lithium-ion battery. However, during the preparation process. the positive electrode material for lithium-ion batteries is only mixed with a conductive agent and a binder according to a certain ratio, and stirred to form a positive electrode slurry, and the preparation method does not have creativity.

CN108899537A discloses a preparation method for a LiNiₓCo_{y}Mn_{1-x-y}O₂ positive electrode material for lithium-ion batteries. A precursor of LiNiₓCo_{y}Mn_{1-x-y}O₂ is prepared by solvothermal/hydrothermal method, in which urea is used as a complexing agent to avoid the segregation of the transition metal ions and ensure the uniform precipitation of the transition metal ions, and then a lithium source is fully mixed to prepare LiNiₓCo_{y}Mn_{1-x-y}O₂ by high-temperature solid-phase method. and then a carbon fiber is added to improve the electrical conductivity, thus improving the rate capability of the LiNiₓCo_{y}Mn_{1-x-y}O₂ positive electrode material. The high-temperature solid-phase method has a simple process, but the material has the uneven phase distribution. irregular grain shape and wide particle size distribution.

CN105742627A discloses a preparation method for a LiNiₓCo_{y}Mn_{1-x-y}Br_{z}O_{2z}/graphene composite positive electrode material, in which a bromine-doped lithium nickel cobalt manganese oxide is prepared by combustion method, and the preparation method comprises: mixing a nickel source, a cobalt source, a manganese source, a bromine source, a lithium salt and an combustion improver according to a certain molar ratio, adding a solvent, stirring, and then preparing a LiNiₓCo_{y}Mn_{1-x-y}Br_{z}O_{2z} positive electrode material by high-temperature solid-phase method, then fully mixing with graphene oxide, and then adding an appropriate amount of a reducing agent, and transferring together to a reaction kettle to react at a certain temperature for a certain time to obtain the LiNiₓCo_{y}Mn_{1-x-y}Br_{z}O_{2z}/graphene composite positive electrode material.

Similarly, the prepared grains are irregular in shape and uneven in size.

Preparation method to obtain a positive electrode material for lithium-ion batteries with low energy consumption, low pollution discharge and high stability is an important research direction in the field of lithium-ion batteries.

### SUMMARY

The present application provides a new positive electrode material for lithium-ion batteries, a preparation method therefor and an application thereof. A precursor of the positive electrode material for lithium-ion battery is prepared by biomineralization method, and then mixed with a lithium source to prepare the positive electrode material for lithium-ion battery. The preparation method has a simple process, and the prepared positive electrode material for lithium-ion battery has high cycle stability, which can improve the electrochemical performance of lithium-ion battery.

To achieve the above technical effects, the present application uses the following technical solutions.

A first object of the present application is to provide a preparation method for a positive electrode material for lithium-ion batteries, and the preparation method comprises the following steps:
(1) preparing a raw material containing a metal ion, a polymer and a solvent into a mixed solution, and allowing the mixed solution to stand with an ammonium source independently in a same space, and performing a solid-liquid separation to obtain a precursor; and
(2) mixing and calcining the precursor in step (1) and a lithium source to obtain a positive electrode material for lithium-ion batteries.

In the preparation method, the same space in step (1) refers to one same confined space, or two independent confined spaces which are communicate by a pipe, where the standing is performed separately in the two confined spaces.

In the present application, the biomineralization method is adopted, and the polyelectrolyte of the biomineralization method plays a structure-directing role in the preparation process of the precursor, so that the positive electrode material more easily generates a regular layered structure without lattice defects. In the present application, the preparation method has a simple process, and stirring and heating are not required during the preparation process of the precursor, saving energy and reducing the generation of the three wastes. The preparation method is easy to be practice and can be applied to industrial production. The positive electrode material for lithium-ion battery prepared by the preparation method has high cycle stability, which can improve the electrochemical performance of the lithium-ion battery.

As an optional technical solution of the present application, the metal ion in step (1) comprises any one or a combination of at least two of manganese, cobalt, nickel, iron, potassium, vanadium, chromium, germanium, niobium, molybdenum, zirconium, aluminum, strontium, magnesium or titanium, and a typical but non-limiting example of the combination comprises: a combination of manganese and cobalt, a combination of nickel and iron, a combination of potassium, vanadium and chromium, a combination of germanium, niobium and molybdenum, a combination of zirconium and aluminum, a combination of aluminum and strontium, or a combination of magnesium and titanium, etc.

Optionally, the raw material containing a metal ion comprises any one or a combination of at least two of a sulfate salt, a chloride salt, an acetate salt or a nitrate salt, and a typical but non-limiting example of the combination comprises: a combination of a sulfate salt and a chloride salt, a combination of a chloride salt and an acetate salt, or a combination of an acetate salt and a nitrate salt, etc.

As an optional technical solution of the present application, the polymer in step (1) is a water-soluble macromolecule having at least one ionizable functional group in a main chain and/or side chain.

Optionally, the polymer comprises any one or a combination of at least two of sodium polyacrylate, hydroxyethyl cellulose, hexamethylenetetramine, octacalcium phosphate, phytic acid, polyacrylic acid, polyaspartic acid, polyallylamine hydrochloride, polyacrylamide, polymethyl methacrylate, polystyrene sulfonic acid. O-phospho-L-serine, 2-[4-dihydroxyl phosphoryl]-2-oxo-butyl-ethyl acrylate, polyethylene glycol, polyethylenimine, polyethylenimine-polyvinyl acid, polyethylenimine-polysulfonic acid, sulfonated polyethylenimine, polyethylene oxide, polyglycidol, polyglutamic acid, poly [2-(2-hydroxyethyl)]ethylene, poly(1,4,7,10,13,16-hexazacyclooctadecane ethylenimine), polymethacrylic acid, alkylated polymethacrylic acid, cetyltrimethylammonium bromide, a hyperbranched polymer, octadecylamine, polyamide-amine, polyethylenimine, polypropyleneimine, sodium dodecyl sulfonate, polyvinylpyrrolidone, ethylenediaminetetraacetic acid, polystyrene-alt-cis-butadiene, polyvinyl alcohol, polymethyl vinyl ether, polyhydroxyethyl methacrylate, polyhydroxypropyl methacrylate, methacrylate, polyisopropylacrylamide, polydimethyl diallyl poly dimethylaminoethyl ammonium chloride, polyhydroxyethyl acrylate or tetraethyl orthosilicate, and a typical but non-limiting example of the combination comprises: a combination of sodium polyacrylate, hydroxyethyl cellulose and hexamethylenetetramine, a combination of octacalcium phosphate, phytic acid and polyacrylic acid, a combination of polyaspartic acid and polyallylamine hydrochloride, a combination of polyacrylamide, polymethyl methacrylate and polystyrene sulfonic acid, a combination of O-phospho-L-serine, 2-[4-dihydroxyl phosphoryl]-2-oxo-butyl-ethyl acrylate and polyethylene glycol, a combination of polyethylenimine and polyethylenimine-polyvinyl acid, a combination of polyethylenimine-polysulfonic acid, sulfonated polyethylenimine and polyethylene oxide, a combination of polyglycidol, polyglutamic acid and poly[2-(2-hydroxyethyl)]ethylene, a combination of poly(1,4,7,10,13,16-hexazacyclooctadecane ethylenimine) and polymethacrylic acid, a combination of alkylated polymethacrylic acid, cetyltrimethylammonium bromide and a hyperbranched polymer, a combination of octadecylamine, polyamide-amine and polyethylenimine, a combination of polypropyleneimine, sodium dodecyl sulfonate and tetraethyl orthosilicate, a combination of polyvinylpyrrolidone, ethylenediaminetetraacetic acid, polystyrene-alt-cis-butadiene and polyvinyl alcohol, a combination of polymethyl vinyl ether, polyhydroxyethyl methacrylate and polyhydroxypropyl methacrylate, a combination of polydimethylaminoethyl methacrylate and polyisopropylacrylamide, or a combination of polydimethyl diallyl ammonium chloride and polyhydroxyethyl acrylate, etc.

Optionally, the solvent in step (1) comprises any one or a combination of at least two of deionized water, ethanol, acetone, N,N-dimethylformamide or tetrahydrofuran, and a typical but non-limiting example of the combination comprises: a combination of deionized water and ethanol, a combination of acetone and ethanol, or a combination of N,N-dimethylformamide and tetrahydrofuran, etc.

As an optional technical solution of the present application, the polymer in the mixed solution of step (1) has a concentration of 0.001-1 g/L, and the concentration can be 0.001 g/L, 0.01 g/L, 0.05 g/L, 0.1 g/L, 0.2 g/L, 0.3 g/L, 0.4 g/L, 0.5 g/L, 0.6 g/L, 0.7 g/L, 0.8 g/L, 0.9 g/L or 1 g/L, etc.; however, the concentration is not limited to the listed values, and other unlisted values within the numerical range are also applicable.

Optionally, the mixed solution has a concentration of 0.001-1 mol/L, and the concentration can be 0.001 mol/L, 0.01 mol/L, 0.05 mol/L, 0.1 mol/L, 0.2 mol/L, 0.3 mol/L, 0.4 mol/L, 0.5 mol/L, 0.6 mol/L, 0.7 mol/L, 0.8 mol/L, 0.9 mol/L or 1 mol/L, etc.; however, the concentration is not limited to the listed values, and other unlisted values within the numerical range are also applicable.

Optionally, the standing is performed for a period of 1-720 h, and the period can be 1 h, 50 h, 100 h, 150 h, 200 h, 250 h, 300 h, 350 h, 400 h, 450 h, 500 h, 550 h, 600 h, 650 h, 700 h or 720 h, etc.; however, the period is not limited to the listed values, and other unlisted values within the numerical range are also applicable.

Optionally, filtration and drying are performed after the solid-liquid separation in step (1).

Optionally, the filtration comprises any one or a combination of at least two of atmospheric filtration, suction filtration or centrifugation, and a typical but non-limiting example of the combination comprises: a combination of atmospheric filtration and suction filtration, a combination of atmospheric filtration and centrifugation, or a combination of suction filtration and centrifugation, etc.

Optionally, the drying comprises any one or a combination of at least two of blast drying, vacuum drying or freeze drying, and a typical but non-limiting example of the combination comprises: a combination of blast drying and vacuum drying, a combination of vacuum drying and freeze drying, or a combination of blast drying and freeze drying, etc.

Optionally, the drying is performed at a temperature of 80-150° C., and the temperature can be 80° C., 90° C., 100° C., 110° C., 120° C., 130° C., 140° C. or 150° C., etc.; however, the temperature is not limited to the listed values, and other unlisted values within the numerical range are also applicable.

Optionally, the drying is performed for a period of 5-20 h, and the period can be 5 h, 6 h, 7 h, 8 h, 9 h, 10 h, 11 h, 12 h, 13 h, 14 h, 15 h, 16 h, 17 h, 18 h, 19 h or 20 h, etc.; however, the period is not limited to the listed values, and other unlisted values within the numerical range are also applicable.

As an optional technical solution of the present application, the mixing and calcination in step (2) can further comprise a phosphorus source.

Optionally, the phosphorus source comprises any one or a combination of at least two of phosphoric acid, ammonium hydrogen phosphate or iron phosphate, and a typical but non-limiting example of the combination comprises: a combination of phosphoric acid and ammonium hydrogen phosphate, a combination of ammonium hydrogen phosphate and iron phosphate, or a combination of phosphoric acid and iron phosphate, etc.

As an optional technical solution of the present application, the ammonium source in step (2) comprises any one or a combination of at least two of ammonium carbonate, ammonium hydrogen carbonate, ammonium dihydrogen carbonate, ammonium hydroxide, ammonium chloride, ammonium nitrate, ammonium sulfate, ammonium hydrogen sulfate, ammonium fluoride, ammonium manganate, ammonium iodide or ammonium bromide, and a typical but non-limiting example of the combination comprises: a combination of ammonium carbonate and ammonium hydrogen carbonate, a combination of ammonium dihydrogen carbonate and ammonium hydroxide, a combination of ammonium chloride and ammonium nitrate, a combination of ammonium sulfate and ammonium hydrogen sulfate, a combination of ammonium fluoride and ammonium manganite, or a combination of ammonium iodide, ammonium bromide and ammonium dihydrogen carbonate, etc.

Optionally, the lithium source comprises any one or a combination of at least two of lithium chloride, lithium sulfate, lithium carbonate, lithium hydroxide, lithium nitrate, lithium acetate or lithium oxalate, and a typical but non-limiting example of the combination comprises: a combination of lithium chloride and lithium sulfate, a combination of lithium carbonate and lithium hydroxide, a combination of lithium nitrate, lithium acetate and lithium oxalate, or a combination of lithium acetate and lithium oxalate, etc.

As an optional technical solution of the present application, the mixing in step (2) comprises manual grinding and ball milling.

Optionally, the ball milling comprises any one or a combination of at least two of dry ball milling, wet ball milling, high-energy ball milling or freeze ball milling, and a typical but non-limiting example of the combination comprises: a combination of dry ball milling and wet ball milling, a combination of high-energy ball milling and freeze ball milling, or a combination of dry ball milling and freeze ball milling, etc.

Optionally, the ball milling is performed at a rotation speed of 200-2000 r/min, and the rotation speed can be 200 r/min, 400 r/min, 600 r/min, 800 r/min, 1000 r/min, 1200 r/min, 1400 r/min, 1600 r/min, 1800 r/min or 2000 r/min, etc.; however, the rotation speed is not limited to the listed values, and other unlisted values within the numerical range are also applicable.

Optionally, the ball milling is performed for a period of 2-12 h, and the period can be 2 h, 3 h, 4 h, 5 h, 6 h, 7h, 8 h, 9 h, 10 h, 11 h or 12 h, etc.; however, the period is not limited to the listed values, and other unlisted values within the numerical range are also applicable.

Optionally, the mixing in step (2) is performed for a period of 0.1-12 h, and the period can be 0.1 h, 1 h, 2 h, 3 h, 4 h, 5 h, 6 h, 7 h, 8 h, 9 h, 10 h, 11 h or 12 h, etc.; however, the period is not limited to the listed values, and other unlisted values within the numerical range are also applicable.

As an optional technical solution of the present application, the calcination in step (2) comprises a first-stage calcination and a second-stage calcination.

Optionally, the first-stage calcination is performed at a temperature of 200-700° C., and the temperature can be 200° C., 250° C., 300° C., 350° C., 400° C., 450° C., 500° C., 550° C., 600° C., 650° C. or 700° C., etc.; however, the temperature is not limited to the listed values, and other unlisted values within the numerical range are also applicable; optionally, the temperature is 350-650° C.

Optionally, the first-stage calcination is performed for a period of 1-15 h, and the period can be 1 h, 2 h, 3 h, 4 h, 5 h, 6 h, 7 h, 8 h, 9 h, 10 h, 11 h or 15 h, etc.; however, the period is not limited to the listed values, and other unlisted values within the numerical range are also applicable; optionally, the period is 2-10 h.

Optionally, the first-stage calcination has a heating rate of 1-10° C./min, and the rate can be 1° C./min, 2° C./min, 3° C./min, 4° C./min, 5° C./min, 6° C./min, 7° C./min, 8° C./min, 9° C./min or 10° C./min, etc.; however, the rate is not limited to the listed values, and other unlisted values within the numerical range are also applicable; optionally, the heating rate is 1-2° C./min.

Optionally, the second-stage calcination is performed at a temperature of 800-1000° C., and the temperature can be 800° C., 820° C., 840° C., 860° C., 880° C., 900° C., 920° C., 940° C., 960° C., 980° C. or 1000° C., etc.; however, the temperature is not limited to the listed values, and other unlisted values within the numerical range are also applicable; optionally, the temperature is 800-950° C.

Optionally, the second-stage calcination is performed for a period of 10-24 h, and the period can be 10 h, 11 h, 12 h, 13 h, 14 h, 15 h, 16 h, 17 h, 18 h, 19 h, 20 h, 21 h, 22 h, 23 h or 24 h, etc.; however, the period is not limited to the listed values, and other unlisted values within the numerical range are also applicable.

Optionally, the second-stage calcination has a heating rate of 1-10° C./min, and the rate can be 1° C./min, 2° C./min, 3° C./min, 4° C./min, 5° C./min, 6° C./min, 7° C./min, 8° C./min, 9° C./min or 10° C./min, etc.; however, the rate is not limited to the listed values, and other unlisted values within the numerical range are also applicable; optionally, the heating rate is 3-8° C./min.

A second object of the present application is to provide a positive electrode material for lithium-ion batteries obtained by the preparation method according to the first aspect.

Optionally, the positive electrode material comprises any one of lithium cobalt oxide LiCoO₂ having a layered structure, lithium nickel oxide LiNiO₂ having a layered structure, LiMn_{1.5}M_{0.5}O₂ having a spinel structure, a layered ternary material LiMO₂ or a lithium-rich positive electrode material xLi₂MnO₃·(1−x)LiMO_{2.}

Optionally, M is any one or a combination of at least two of Mn, Co, Ni, Fe, K, V, Cr, Ge, Nb, Mo, Zr, Al, Sr, Mg or Ti, and a typical but non-limiting example of the combination comprises: a combination of Mn and Co, a combination of Ni and Fe, a combination of K and V, a combination of Cr and Ge, a combination of Nb and Mo, a combination of Zr and Al, a combination of Sr and Mg, or a combination of Mg and Ti, etc., wherein 0<x≤1, and the value of x can be 0, 0.1, 0.2, 0.3, 0.4, 0.5, 0.6, 0.7, 0.8, 0.9 or 1, etc.; however, the value is not limited to the listed values, and other unlisted values within the numerical range are also applicable.

A third object of the present application is to provide an application of the positive electrode material for lithium-ion batteries according to the second aspect, and the positive electrode material for lithium-ion batteries is applied to the field of lithium-ion batteries.

Compared with the prior art, the present application has at least the following beneficial effects.

In the present application, a precursor of the positive electrode material for lithium-ion battery is prepared by using biomineralization method, and then mixed with a lithium source to prepare the positive electrode material for lithium-ion battery. The preparation method has a simple process, and stirring and heating are not required during the preparation process of the precursor, saving energy and reducing the generation of the three wastes. The preparation method is easy to practice and can be applied to industrial production. The positive electrode material for lithium-ion battery prepared by the preparation method has high cycle stability, which can improve the electrochemical performance of the lithium-ion battery. The prepared lithium-ion battery has an initial discharge specific capacity of 285 mAhg⁻¹ and a cycle stability of 95% after 200 cycles.

### DETAILED DESCRIPTION

The technical solutions of the present application are further described below via specific embodiments. However, the following examples are only simple examples of the present application and do not represent or limit the protection scope of the present application, and the protection scope of the present application is defined by the claims.

### Example 1

The example provides a preparation method for a positive electrode material for lithium-ion batteries, and the preparation method comprises the following steps:
(1) preparation of positive electrode material for lithium-ion batteries: manganese nitrate, nickel nitrate and cobalt nitrate were weighed out according to a molecular formula of Li_{1.2}Mn_{0.6}Ni_{0.15}Co_{0.05}O₂, i.e., a molar ratio of 0.6:0.15:0.05, and dissolved in deionized water to form a mixed salt solution of 0.05 mol/L, and then added with polyacrylamide to 0.05 g/L to obtain a mixed solution, the mixed solution was poured into a crystallization dish, and sealed with a parafilm, and small holes were punched on the parafilm; then ammonium carbonate was added to a glass bottle and sealed with a parafilm, and small holes were punched on the parafilm; the above crystallization dish and glass bottle were put into a desiccator, and allowed to stand for 168 h; after filtration, washing and then drying at 105° C. for 12 h, a precursor of positive electrode material for lithium batteries was obtained; and
(2) preparation of positive electrode material for lithium-ion batteries: lithium carbonate and the precursor of positive electrode material for lithium batteries were weighed out according to a molecular formula of Li_{1.2}Mn_{0.6}Ni_{0.15}Co_{0.05}O₂, i.e., a molar ratio of 1.2:0.8, subjected to ball milling for 0.5 h, heated to 500° C. at 5° C./min, subjected to heat preservation for 5 h, and then heated to 900° C. at 5° C./min and subjected to heat preservation for 12 h to obtain the positive electrode material for lithium batteries.

### Example 2

The example provides a preparation method for a positive electrode material for lithium-ion batteries, and the preparation method comprises the following steps:
(1) preparation of positive electrode material for lithium-ion batteries: manganese chloride, nickel chloride and cobalt chloride were weighed out according to a molecular formula of Li_{1.2}Mn_{0.55}Ni_{0.15}Co_{0.1}O₂, i.e., a molar ratio of 0.55:0.15:0.1, and dissolved in ethanol to form a mixed salt solution of 0.01 mol/L, and then added with polyaspartic acid to 0.001 g/L to obtain a mixed solution, the mixed solution was poured into a crystallization dish, and sealed with a parafilm, and small holes were punched on the parafilm; then ammonium carbonate was added to a glass bottle and sealed with a parafilm, and small holes were punched on the parafilm; the above crystallization dish and glass bottle were put into a desiccator, and allowed to stand for 192 h; after filtration, washing and then drying at 105° C. for 12 h, a precursor of positive electrode material for lithium batteries was obtained; and
(2) preparation of positive electrode material for lithium-ion batteries: lithium carbonate and the precursor of positive electrode material for lithium batteries were weighed out according to a molecular formula of Li_{1.2}Mn_{0.55}Ni_{0.15}Co_{0.1}O₂ , i.e., a molar ratio of 1.2:0.8, ground for 2 h, heated to 500° C. at 5° C./min, subjected to heat preservation for 5 h, and then heated to 900° C. at 5° C./min and subjected to heat preservation for 12 h to obtain the positive electrode material for lithium batteries.

### Example 3

The example provides a preparation method for a positive electrode material for lithium-ion batteries, and the preparation method comprises the following steps:
(1) preparation of positive electrode material for lithium-ion batteries: manganese acetate, nickel acetate and cobalt acetate were weighed out according to Li_{1.2}Mn_{0.55}Ni_{0.15}Co_{0.1}O₂, i.e., a molar ratio of 0.55:0.15:0.1, and dissolved in acetone to form a mixed salt solution of 0.012 mol/L, and then added with polyacrylic acid to 0.01 g/L to obtain a mixed solution, the mixed solution was poured into a crystallization dish, and sealed with a parafilm, and small holes were punched on the parafilm; then ammonium carbonate was added to a glass bottle and sealed with a parafilm, and small holes were punched on the parafilm; the above crystallization dish and glass bottle were put into a desiccator, and allowed to stand for 336 h; after filtration, washing and then drying at 105° C. for 12 h, a precursor of positive electrode material for lithium batteries was obtained; and
(2) preparation of positive electrode material for lithium-ion batteries: lithium carbonate and the precursor of positive electrode material for lithium batteries were weighed out according to a molecular formula of Li_{1.2}Mn_{0.55}Ni_{0.15}Co_{0.01}O₂, i.e., a molar ratio of 1.2:0.8, subjected to ball milling for 5 h, heated to 600° C. at 5° C./min, subjected to heat preservation for 5 h, and then heated to 900° C. at 5° C./min and subjected to heat preservation for 12 h to obtain the positive electrode material for lithium batteries.

### Example 4

The example provides a preparation method for a positive electrode material for lithium-ion batteries, and the preparation method comprises the following steps:
(1) preparation of positive electrode material for lithium-ion batteries: manganese chloride, nickel chloride and cobalt chloride were weighed out according to a molecular formula of Li_{1.2}Mn_{0.64}Ni_{0.08}Co_{0.08}O₂, i.e., a molar ratio of 0.64:0.08:0.08, and dissolved in N,N-dimethylformamide to form a mixed salt solution of 0.05 mol/L, and then added with octacalcium phosphate to 0.01 g/L to obtain a mixed solution, the mixed solution was poured into a crystallization dish, and sealed with a parafilm, and small holes were punched on the parafilm; then ammonium carbonate was added to a glass bottle and sealed with a parafilm, and small holes were punched on the parafilm; the above crystallization dish and glass bottle were put into a desiccator, and allowed to stand for 240 h; after filtration, washing and then drying at 105° C. for 12 h, a precursor of positive electrode material for lithium batteries was obtained; and
(2) preparation of positive electrode material for lithium-ion batteries: lithium carbonate and the precursor of positive electrode material for lithium batteries were weighed out according to a molecular formula of Li_{1.2}Mn_{0.64}Ni_{0.08}Co_{0.08}O₂, i.e., a molar ratio of 1.2:0.8, ground for 0.5 h, heated to 600° C. at 5° C./min, subjected to heat preservation for 5 h, and then heated to 900° C. at 5° C./min and subjected to heat preservation for 12 h to obtain the positive electrode material for lithium batteries.

### Example 5

The example provides a preparation method for a positive electrode material for lithium-ion batteries, and the preparation method comprises the following steps:
(1) preparation of positive electrode material for lithium-ion batteries: manganese chloride, nickel chloride and cobalt chloride were weighed out according to a molecular formula of Li_{1.2}Mn_{0.48}Ni_{0.16}Co_{0.16}O₂, i.e., a molar ratio of 0.48:0.16:0.16, and dissolved in tetrahydrofuran to form a mixed salt solution of 0.5 mol/L, and then added with polyethylene glycol to 0.01 g/L to obtain a mixed solution, the mixed solution was poured into a crystallization dish, and sealed with a parafilm, and small holes were punched on the parafilm; then ammonium carbonate was added to a glass bottle and sealed with a parafilm, and small holes were punched on the parafilm; the above crystallization dish and glass bottle were put into a desiccator, and allowed to stand for 240 h; after filtration, washing and then drying at 105° C. for 12 h, a precursor of positive electrode material for lithium batteries was obtained; and
(2) preparation of positive electrode material for lithium-ion batteries: lithium carbonate and the precursor of positive electrode material for lithium batteries were weighed out according to a molecular formula of Li_{1.2}Mn_{0.48}Ni_{0.16}Co_{0.16}O₂, i.e., a molar ratio of 1.2:0.8, subjected to ball milling for 0.5 h, heated to 600° C. at 5° C./min, subjected to heat preservation for 5 h, and then heated to 900° C. at 5° C./min and subjected to heat preservation for 12 h to obtain the positive electrode material for lithium batteries.

### Example 6

The example provides a preparation method for a positive electrode material for lithium-ion batteries, and the preparation method comprises the following steps:
(1) preparation of positive electrode material for lithium-ion batteries: manganese chloride, nickel chloride and cobalt chloride were weighed out according to a molecular formula of Li_{1.2}Mn_{0.48}Ni_{0.16}Co_{0.16}O₂, i.e., a molar ratio of 0.48:0.16:0.16, and dissolved in deionized water to form a mixed salt solution of 0.05 mol/L, and then added with polyethylene glycol to 0.01 g/L to obtain a mixed solution, the mixed solution was poured into a crystallization dish, and sealed with a parafilm, and small holes were punched on the parafilm; then ammonium carbonate was added to a glass bottle and sealed with a parafilm, and small holes were punched on the parafilm; the above crystallization dish and glass bottle were put into a desiccator, and allowed to stand for 240 h; after filtration, washing and then drying at 105° C. for 12 h, a precursor of positive electrode material for lithium batteries was obtained; and
(2) preparation of positive electrode material for lithium-ion batteries: lithium carbonate and the precursor of positive electrode material for lithium batteries were weighed out according to a molecular formula of Li_{1.2}Mn_{0.48}Ni_{0.16}Co_{0.16}O₂, i.e., a molar ratio of 1.2:0.8, ground for 1 h, heated to 450° C. at 5° C./min, subjected to heat preservation for 5 h, and then heated to 900° C. at 5° C./min and subjected to heat preservation for 12 h to obtain the positive electrode material for lithium batteries.

### Example 7

The example provides a preparation method for a positive electrode material for lithium-ion batteries, and the preparation method comprises the following steps:
(1) preparation of positive electrode material for lithium-ion batteries: manganese nitrate, nickel nitrate and aluminum nitrate were weighed out according to a molecular formula of Li_{1.2}Mn_{0.6}Ni_{0.15}Al_{0.05}O₂, i.e., a molar ratio of 0.6:0.15:0.05, and dissolved in deionized water to form a mixed salt solution of 0.05 mol/L, and then added with polyethylene glycol to 0.05 g/L to obtain a mixed solution, the mixed solution was poured into a crystallization dish, and sealed with a parafilm, and small holes were punched on the parafilm; then ammonium carbonate was added to a glass bottle and sealed with a parafilm, and small holes were punched on the parafilm; the above crystallization dish and glass bottle were put into a desiccator, and allowed to stand for 264 h; after filtration, washing and then drying at 105° C. for 12 h, a precursor of positive electrode material for lithium batteries was obtained; and
(2) preparation of positive electrode material for lithium-ion batteries: lithium carbonate and the precursor of positive electrode material for lithium batteries were weighed out according to a molecular formula of Li_{1.2}Mn_{0.6}Ni_{0.15}Al_{0.05}O₂, i.e., a molar ratio of 1.2:0.8, subjected to ball milling for 0.5 h, heated to 450° C. at 5° C./min, subjected to heat preservation for 5 h, and then heated to 850° C. at 5° C./min and subjected to heat preservation for 12 h to obtain the positive electrode material for lithium batteries.

### Example 8

The example provides a preparation method for a positive electrode material for lithium-ion batteries, and the preparation method comprises the following steps:
(1) preparation of positive electrode material for lithium-ion batteries: cobalt acetate was weighed out according to a molecular formula of LiCoO_{2,} and dissolved in deionized water to form a mixed salt solution of 0.05 mol/L, and then added with polyethylene glycol to 0.05 g/L to obtain a mixed solution, the mixed solution was poured into a crystallization dish, and sealed with a parafilm, and small holes were punched on the parafilm; then ammonium carbonate was added to a glass bottle and sealed with a parafilm, and small holes were punched on the parafilm; the above crystallization dish and glass bottle were put into a desiccator, and allowed to stand for 264 h; after filtration, washing and then drying at 105° C. for 12 h, a precursor of positive electrode material for lithium batteries was obtained; and
(2) preparation of positive electrode material for lithium-ion batteries: lithium carbonate and the precursor of positive electrode material for lithium batteries were weighed out according to a molecular formula of LiCoO_{2,} i.e., a molar ratio of 1:1, ground for 0.5 h, heated to 450° C. at 5° C./min, subjected to heat preservation for 5 h, and then heated to 850° C. at 5° C./min and subjected to heat preservation for 12 h to obtain the positive electrode material for lithium batteries.

### Example 9

The example provides a preparation method for a positive electrode material for lithium-ion batteries, and the preparation method comprises the following steps:
(1) preparation of positive electrode material for lithium-ion batteries: nickel chloride was weighed out according to a molecular formula of LiNiO_{2,} and dissolved in deionized water to form a mixed salt solution of 0.15 mol/L, and then added with polyacrylic acid to 0.15 g/L to obtain a mixed solution, the mixed solution was poured into a crystallization dish, and sealed with a parafilm, and small holes were punched on the parafilm; then ammonium carbonate was added to a glass bottle and sealed with a parafilm, and small holes were punched on the parafilm; the above crystallization dish and glass bottle were put into a desiccator, and allowed to stand for 264 h; after filtration, washing and then drying at 105° C. for 12 h, a precursor of positive electrode material for lithium batteries was obtained; and
(2) preparation of positive electrode material for lithium-ion batteries: lithium carbonate and the precursor of positive electrode material for lithium batteries were weighed out according to a molecular formula of LiNiO_{2,} i.e., a molar ratio of 1:1, subjected to ball milling for 0.5 h, heated to 450° C. at 5° C./min, subjected to heat preservation for 5 h, and then heated to 850° C. at 5° C./min and subjected to heat preservation for 12 h to obtain the positive electrode material for lithium batteries.

### Example 10

The example provides a preparation method for a positive electrode material for lithium-ion batteries, and the preparation method comprises the following steps:
(1) preparation of positive electrode material for lithium-ion batteries: manganese chloride, nickel chloride and cobalt chloride were weighed out according to a molecular formula of Li_{1.2}Mn_{0.333}Ni_{0.333}Co_{0.333}O₂, i.e., a molar ratio of 1:1:1, and dissolved in deionized water to form a mixed salt solution of 0.05 mol/L, and then added with polyethylene glycol to 0.05 g/L to obtain a mixed solution, the mixed solution was poured into a crystallization dish, and sealed with a parafilm, and small holes were punched on the parafilm; then ammonium carbonate was added to a glass bottle and sealed with a parafilm, and small holes were punched on the parafilm; the 15 above crystallization dish and glass bottle were put into a desiccator, and allowed to stand for 264 h; after filtration, washing and then drying at 105° C. for 12 h, a precursor of positive electrode material for lithium batteries was obtained; and
(2) preparation of a positive electrode material for lithium-ion batteries: lithium carbonate and the precursor of positive electrode material for lithium batteries were weighed out according to 20 a molecular formula of Li_{1.2}Mn_{0.333}Ni_{0.333}Co_{0.333}O₂, i.e., a molar ratio of 1:1, ground for 0.5 h, heated to 450° C. at 5° C./min, subjected to heat preservation for 5 h, and then heated to 850° C. at 5° C./min and subjected to heat preservation for 12 h to obtain the positive electrode material for lithium batteries.

### Example 11

In this example, the conditions are the same as in Example 1, except that cobalt sulfate in step (1) was replaced with magnesium sulfate.

### Example 12

In this example, the conditions are the same as in Example 1, except that the standing in step (1) was performed for 744 h.

### Example 13

In this example, the conditions are the same as in Example 1, except that the concentration of polyacrylamide in step (1) was 1.2 mol/L.

### Example 14

In this example, the conditions are the same as in Example 1, except that the concentration of the mixed salt solution in step (1) was 1.2 mol/L.

### Example 15

In this example, the conditions are the same as in Example 1, except that the calcination in step (2) was performed at a temperature of 950° C.

### Example 16

In this example, the conditions are the same as in Example 1, except that the calcination in step (2) was performed at a temperature of 400° C.

### Example 17

In this example, the conditions are the same as in Example 1, except that the calcination in step (2) was performed for a period of 4 h.

### Example 18

In this example, Li_{1.2}Mn_{0.6}Ni_{0.15}Co_{0.05}O₂ was replaced with lithium iron phosphate. (1) Ferric chloride was weighed out and dissolved in deionized water to form a mixed salt solution of 0.05 mol/L, and then added with polyethylene glycol to 0.05 g/L to obtain a mixed solution, the mixed solution was poured into a crystallization dish, and sealed with a parafilm, and small holes were punched on the parafilm; then ammonium carbonate was added to a glass bottle and sealed with a parafilm, and small holes were punched on the parafilm. The above crystallization dish and glass bottle were put into a desiccator, and allowed to stand for 264 h; after filtration, washing and then drying at 105° C. for 12 h, a precursor of positive electrode material for lithium batteries was obtained.
(2) Preparation of positive electrode material for lithium-ion batteries: lithium carbonate, the precursor of positive electrode material for lithium batteries and ammonium dihydrogen phosphate were weighed out according to a molecular formula of LiFePO_{4,} i.e., a molar ratio of 1:1:1, subjected to ball milling for 2 h, heated to 450° C. at 5° C./min, subjected to heat preservation for 5 h, and then heated to 850° C. at 5° C./min and subjected to heat preservation for 12 h to obtain the positive electrode material for lithium batteries.

### Comparative Example 1

In this comparative example, the conditions are the same as in Example 1, except that in step (1), no polyacrylamide was added.

The positive electrode materials provided by Examples 1-18 and Comparative Example 1 are prepared into batteries, and the prepared batteries are tested for the charge-discharge capacity retention rate. The results are shown in Table 1.

The positive electrode materials prepared in Examples 1-18 and Comparative Example 1 used as a positive electrode active substance is uniformly mixed with polyvinylidene fluoride (PVDF) and superconducting carbon black according to a mass ratio of 8:1:1, and added with N-methylpyrrolidone (NMP) to prepare a slurry; the slurry is coated on aluminum foil, and dried at vacuum to obtain a positive electrode plate.

A metal lithium plate is used as a negative electrode, and the positive electrode, negative electrode, electrolytical solution and separator are assembled into a button battery. The battery is subjected to charge-discharge test with a voltage range of 2.0-4.8 V and a current density of 25 mA g⁻¹ The capacity retention rate of the battery after 200 cycles is tested.

TABLE 1

| | Capacity retention rate |
|---|---|
| Example 1 | 95% |
| Example 2 | 91% |
| Example 3 | 93% |
| Example 4 | 92% |
| Example 5 | 94% |
| Example 6 | 89% |
| Example 7 | 90% |
| Example 8 | 91% |
| Example 9 | 88% |
| Example 10 | 89% |
| Example 11 | 86% |
| Example 12 | 84% |
| Example 13 | 83% |
| Example 14 | 83% |
| Example 15 | 83% |
| Example 16 | 70% |
| Example 17 | 71% |
| Example 18 | 95% |
| Comparative Example 1 | 80% |

The positive electrode materials obtained with or without the addition of polyelectrolyte are compared in performance. During the preparation process of the precursor, the electrolyte can regulate the rate of nucleation and growth of grains, the grains of the precursor are controlled to grow along the same direction, and the structure is more regular. The precursor is mixed with a lithium source and calcined to generate the positive electrode material with a stable structure, thus greatly improving the electrochemical stability of the material. However, the structure of the precursor without polyelectrolyte is disordered and unstable, which is not conducive to the diffusion of lithium ions.

The applicant declares that the detailed structural features of the present application are illustrated by means of the above examples in the present application, but the present application is not limited to the above detailed structural features, that is, the present application does not necessarily rely on the above detailed structural features to be implemented.

1. A preparation method for a positive electrode material for lithium-ion batteries, comprising the following steps:
(1) preparing a raw material containing a metal ion, a polymer and a solvent into a mixed solution, and allowing the mixed solution to stand with an ammonium source independently in a same space, and performing a solid-liquid separation to obtain a precursor; and
(2) mixing and calcining the precursor in step (1) and a lithium source to obtain a positive electrode material for lithium-ion batteries.

2. The preparation method according to claim 1, wherein the metal ion in step (1) comprises any one or a combination of at least two of manganese, cobalt, nickel, iron, potassium, vanadium, chromium, germanium, niobium, molybdenum, zirconium, aluminum, strontium, magnesium or titanium.

3. The preparation method according to claim 1, wherein the polymer in step (1) is a water-soluble macromolecule having at least one ionizable functional group in a main chain and/or side chain.

4. The preparation method according to any one of claim 1, wherein the raw material containing a metal ion comprises any one or a combination of at least two of a sulfate salt, a chloride salt, an acetate salt or a nitrate salt.

5. The preparation method according to any one of claim 1, wherein the polymer comprises any one or a combination of at least two of sodium polyacrylate, hydroxyethyl cellulose, hexamethylenetetramine, octacalcium phosphate, phytic acid, polyacrylic acid, polyaspartic acid, polyallylamine hydrochloride, polyacrylamide, polymethyl methacrylate, polystyrene sulfonic acid, O-phospho-L-serine, 2-[4-dihydroxyl phosphoryl]-2-oxo-butyl-ethyl acrylate, polyethylene glycol, polyethylenimine, polyethylenimine-polyvinyl acid, polyethylenimine-polysulfonic acid, sulfonated polyethylenimine, polyethylene oxide, polyglycidol, polyglutamic acid, poly[2-(2-hydroxyethyl)] ethylene, poly(1,4,7,10,13,16-hexazacyclooctadecane ethylenimine), polymethacrylic acid, alkylated polymethacrylic acid, cetyltrimethylammonium bromide, a hyperbranched polymer, octadecylamine, polyamide-amine, polyethylenimine, polypropyleneimine, sodium dodecyl sulfonate, polyvinylpyrrolidone, ethylenediaminetetraacetic acid, polystyrene-alt-cis-butadiene, polyvinyl alcohol, polymethyl vinyl ether, polyhydroxyethyl methacrylate, polyhydroxypropyl methacrylate, polydimethylaminoethyl methacrylate, polyisopropylacrylamide, polydimethyl diallyl ammonium chloride, polyhydroxyethyl acrylate or tetraethyl orthosilicate;

6. The preparation method according to claim 1, wherein the polymer in the mixed solution of step (1) has a concentration of 0.001-1 g/L;
optionally, the standing is performed for a period of 1-720 h;
optionally, filtration and drying are performed after the solid-liquid separation in step (1);
optionally, the filtration comprises any one or a combination of at least two of atmospheric filtration, suction filtration or centrifugation;
optionally, the drying comprises any one or a combination of at least two of blast drying, vacuum drying or freeze drying;
optionally, the drying is performed at a temperature of 80-150° C.;
optionally, the drying is performed for a period of 5-20 h.

7. The preparation method according to claim 1, wherein the mixing and calcination in step (2) further comprise a phosphorus source.

8. The preparation method according to claim 7, wherein the phosphorus source comprises any one or a combination of at least two of phosphoric acid, ammonium hydrogen phosphate or iron phosphate.

9. The preparation method according to claim 1, wherein the ammonium source in step (2) comprises any one or a combination of at least two of ammonium carbonate, ammonium hydrogen carbonate, ammonium dihydrogen carbonate, ammonium hydroxide, ammonium chloride, ammonium nitrate, ammonium sulfate, ammonium hydrogen sulfate, ammonium fluoride, ammonium manganate, ammonium iodide or ammonium bromide;
optionally, the lithium source comprises any one or a combination of at least two of lithium chloride, lithium sulfate, lithium carbonate, lithium hydroxide, lithium nitrate, lithium acetate or lithium oxalate.

10. The preparation method according to claim 1, wherein the mixing in step (2) comprises manual grinding and ball milling;
optionally, the ball milling comprises any one or a combination of at least two of dry ball milling, wet ball milling, high-energy ball milling or freeze ball milling;
optionally, the ball milling is performed at a rotation speed of 200-2000 r/min;
optionally, the ball milling is performed for a period of 2-12 h;
optionally, the mixing in step (2) is performed for a period of 0.1-12 h.

11. The preparation method according to any one of claim 1, wherein the calcination in step (2) comprises a first-stage calcination and a second-stage calcination;

12. A positive electrode material for lithium-ion batteries, which is prepared by the preparation method according to any one of claim 1;
optionally, the positive electrode material comprises any one of lithium cobalt oxide LiCoO₂ having a layered structure, lithium nickel oxide LiNiO₂ having a layered structure, LiMn_{1.5}M_{0.5}O₂ having a spinel structure, a layered ternary material LiMO_{2,} a lithium-rich positive electrode material xLi₂MnO₃·(1−x) LiMO₂ or lithium iron phosphate;
optionally, M is any one or a combination of at least two of Mn, Co, Ni, Fe, K, V, Cr, Ge, Nb, Mo, Zr, Al, Sr, Mg or Ti, and 0<x≤1.

13. (canceled)

14. The preparation method according to claim 1, wherein the solvent in step (1) comprises any one or a combination of at least two of deionized water, ethanol, acetone, N,N-dimethylformamide or tetrahydrofuran.

15. The preparation method according to claim 1, wherein the mixed solution has a concentration of 0.001-1 mol/L.

16. The preparation method according to claim 11, wherein the first-stage calcination is performed at a temperature of 200-700° C., optionally, 350-650° C.

17. The preparation method according to claim 11, wherein the first-stage calcination is performed for a period of 1-15 h, optionally, 2-10 h.

18. The preparation method according to claim 11, wherein the first-stage calcination has a heating rate of 1-10° C./min, optionally, 1-2° C./min.

19. The preparation method according to claim 11, wherein the second-stage calcination is performed at a temperature of 800-1000° C., optionally, 800-950° C.

20. The preparation method according to claim 11, wherein the second-stage calcination is performed for a period of 10-24 h.

21. The preparation method according to claim 11, wherein the second-stage calcination has a heating rate of 1-10° C./min, optionally, 3-8° C./min.
